(19) United States
(12) Patent Application Publication
(10) Pub. No.: US 2006/0056170 A1
(43) Pub. Date: Mar. 16, 2006

(54) Sign-type lighting fixture assembly

(75) Inventors: Bane Todorovic, Dollard-Des-Ormeaux (CA); Roman Majewski, Pierrefonds (CA); Yves Duchesne, Laval (CA)

Correspondence Address: HOFFMAN & BARON, LLP, 6900 JERICHO TURNPIKE, SYOSSET, NY, 11791, US

(73) Assignee: Thomas & Betts International, Inc.

(21) Appl. No.: 11/221,024

(22) Filed: Sep. 7, 2005

Related U.S. Application Data
(60) Provisional application No. 60/609,594, filed on Sep. 14, 2004.

(51) Int. Cl. F21V 33/00

(52) U.S. Cl. 362/97; 362/812; 362/806; 362/604; 362/559; 362/33; 362/365

(57) ABSTRACT

A lighting fixture assembly for mounting to an electrical box. The assembly includes a lighting fixture having perimetrical wall structure to support a signage and illuminating means to illuminate the signage. The assembly further includes a canopy for attaching the fixture to the box. The canopy includes extending bendable tabs which are insertable into openings of the wall structure for mounting the canopy to the fixture without need for additional securement hardware.

### CROSS-REFERENCE TO RELATED APPLICATIONS

This application claims the benefit of U.S. Provisional Application No. 60/609,594 filed on Sep. 14, 2004, entitled “SIGN-TYPE LIGHTING FIXTURE ASSEMBLY”.

### FIELD OF INVENTION

The present invention relates generally to a lighting fixture assembly of the type used to support signage such as an exit sign. More particularly, the present invention relates to an exit sign lighting fixture which may be quickly and easily installed.

### BACKGROUND ON THE INVENTION

The need for illuminated signage, such as exit signs, in buildings and other public areas is well known. These signs typically include lighting fixtures having a housing which supports internal illumination means for illuminating a sign supported by the housing. These fixtures are usually mounted in elevated locations by use of a canopy. The canopy serves as an attachment device for attaching the fixture to electrical box in either a ceiling or a wall, and for allowing for passage of electrical wires therethrough to supply power to the illuminating means in the lighting fixture. Many of these fixtures, including the canopy, are formed from sheet metal steel. This construction is chosen for its strength and low cost.

One such example of a sign-type lighting fixture assembly employing a canopy is shown in U.S. Pat. No. 6,082,031. The canopy shown in the '031 patent is attachable to an electrical box. The canopy includes an extending flange which extends into the housing of the lighting fixture and secured to the lighting fixture by screws which fasten the extending flange to the fixture. Such securement hardware is necessary where the fixture and canopy is formed from sheet metal, as opposed to plastic or die cast metal, where securement may be more easily accomplished. As these sign type lighting fixtures are typically installed in elevated locations and are often awkward to access, it can be appreciated that the need to employ installing screws and tools such as screwdrivers, makes the installation process difficult and time consuming. Moreover the fastening hardware can become misplaced, further increasing the time and cost of installation.

It is therefore desirable to provide a lighting fixture assembly including a lighting fixture attachable to a canopy without the use of separate fastening hardware.

### SUMMARY OF THE INVENTION

The present invention provides a sign-type lighting fixture assembly for mounting to an electrical box. The assembly includes a lighting fixture including a housing having perimetrical walls. A sign supported by the housing wall also supports illuminating means for illuminating the sign. A canopy is provided for attaching the fixture to the box and permitting passage of electrical wiring from the box into the housing for supplying power to the illuminating means. The canopy includes extending bendable tabs which are insertable into openings into one of the walls of the housing for mounting the canopy to the housing without need for additional securement hardware.

The openings on the housing may be provided in one of the plurality of the walls so that the housing may be mounted either to wall or a ceiling.

### BRIEF DESCRIPTION OF THE DRAWINGS

FIG. 1 shows the sign-type lighting fixture assembly of present invention in exploded view.

FIG. 2 shows the insertion of a sign into the lighting fixture assembly of FIG. 1.

FIGS. 3, 4, and 5 show, respectively, top end and side plan views of the canopy employed with the light fixture assembly of FIG. 1.

### DETAILED DESCRIPTION OF DRAWINGS

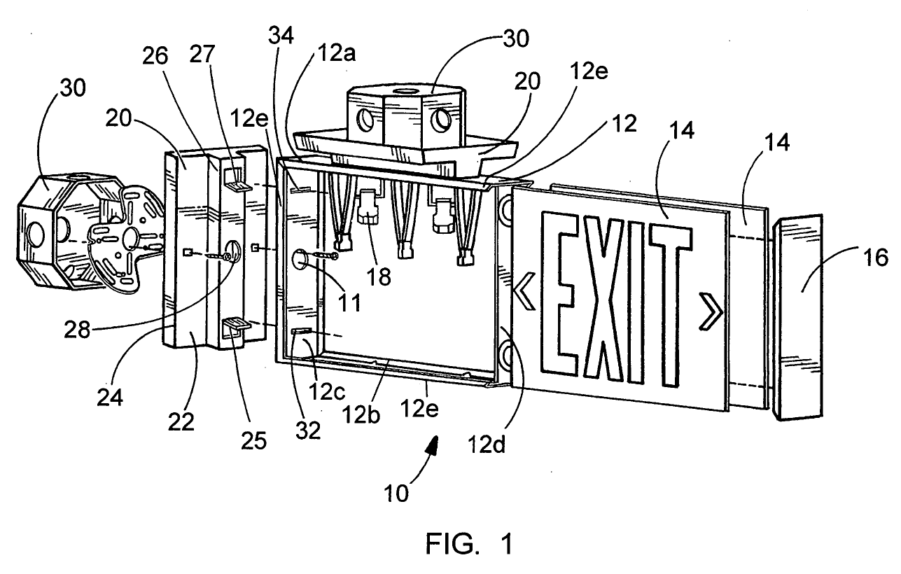

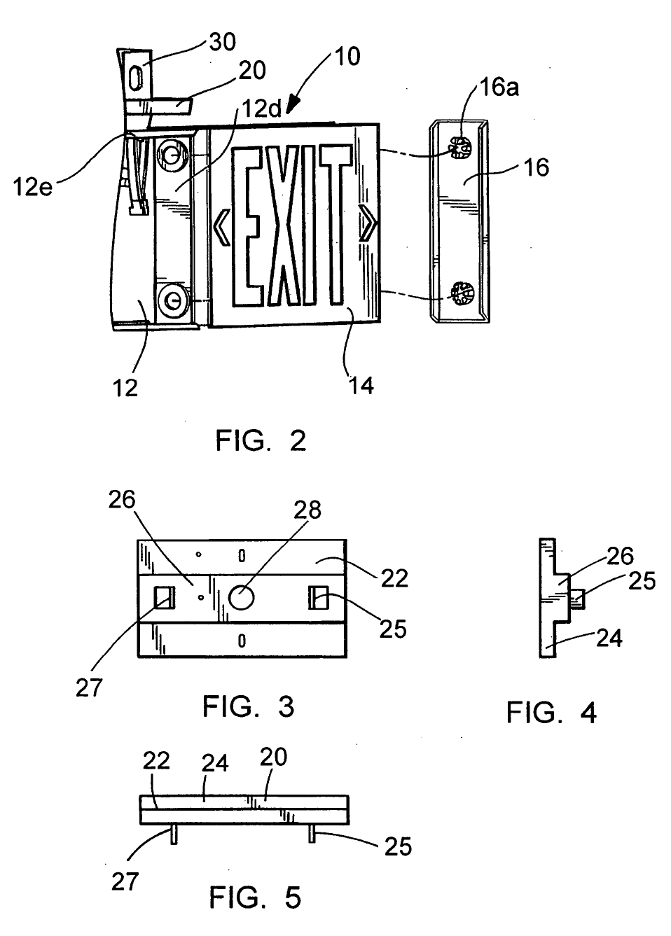

Referring to FIGS. 1 and 2, the present invention provides a canopy for quickly and easily attaching a lighting fixture to a wall or ceiling. In the present illustrated embodiment the particular lighting fixture employed is an illuminated sign such as an illuminated emergency exit sign, however, the present invention is not limited thereto.

As particularly shown in FIG. 1, the lighting fixture 10 is an illuminated emergency exit sign, having a perimetrical wall structure 12, including top and bottom walls 12a and 12b, and opposed side walls 12c and 12d. The perimetrical wall structure 12 defines a generally rectangular configuration. As is well known in the art, the perimetrical wall structure supports front and back signage faces 14, which typically have and an opaque or translucent character so that they may be appropriately backlit. The perimetrical wall structure 12 supports the signage by slidable accommodation therein. As shown in FIG. 2, flanges 12e on three of the walls help support the signage face 14. An end cap 16 secures the signage 14 within the parametrical wall structure 12. The end cap 16 includes snap-in elements 16a to secure the end cap 16 to the side wall 12d.

The perimetrical wall structure 12 further supports illuminating elements 18, which support lamps to provide the back light illumination for the signage 14. The use of lamp sockets, and associated components are well known in the art.

Further, the present invention employs a canopy 20 to secure the lighting fixture 10 to either a wall or a ceiling. FIG. 1 shows two such canopies 20 positioned in either a ceiling mount or a wall mount configuration. As may be appreciated, the FIG. 1 depiction of both canopies 20 is for illustrative purposes only. In use, only one canopy would be employed to secure the lighting fixture 10 to either the wall or the ceiling.

The canopy 20 is formed of metal and is typically used to support lighting fixture 10 to wall or a ceiling so as to overlie an electrical box 30 supported by the wall or the ceiling. The electrical box 30 houses appropriate electrical wires (not shown) for supplying power to illuminating elements 18 of lighting fixture 10. The electrical supply for the illuminating elements is again conventional in design.

The canopy 20 of the present invention allows a quick and secure connection of the canopy to the perimetrical wall structure 12.

Referring additionally to FIGS. 3-5, the canopy is generally of rectangular configuration. The canopy 20 includes a planar surface 22 having an upwardly extending perimetrical lip 24 therearound. The canopy 20 includes a central extension trough 26, extending therealong. The trough 26 has a central aperture 28 therethrough for allowing passage of electrical wires and the like from the electrical box 30 through the canopy 20 and into the lighting fixture 10. An opening 11 is provided in side wall 12c and upper wall 12a to facilitate entry of wires into light fixture 10.

At opposite ends of the elongate trough 26, canopy 20 includes bent out tabs 25 and 27. Tabs 25 and 27 are bent out from a planar surface of trough 26 so as to be positioned substantially at 900 to the plane of the canopy. The tabs 25 and 27 are designed to be insertable into a pair of aligned slits 32 and 34, which are positioned in both one of the side walls 12c as well as the upper wall 12a of perimetrical wall 12. The slits allow the canopy to be attached to either the side wall 12c or upper wall 12a, with the tabs 25 and 27 being insertably accommodate within slits 32 and 34 respectively.

Once accommodated in such fashion, the tabs 25 and 27 may be outwardly bent to secure the canopy to the perimetrical wall 12. The tabs 25 and 27 may be bent either inwardly or outwardly, depending upon desire or particular construction. Such securement is thereby provided without the need for additional securement hardware such as screws and bolts. This arrangement allows the installers to quickly and easily assemble the light fixture to the canopy once the canopy is attached to the box in either the ceiling mount or the wall mount configuration.

Various changes to the foregoing described and shown structures will now be evident to those skilled in the art. Accordingly, the particularly disclosed scope of the invention is set forth in the following claims.

What is claimed:

1. A sign-type lighting fixture assembly for mounting to an electrical box comprising:
a lighting fixture including housing having perimetrical walls, a sign supported by the housing walls and illuminating means for illuminating said sign; and
a canopy for attaching said fixture to said box and permitting passage of electrical wiring from said box into said housing for supplying power to said illuminating means;
said canopy including extending bendable tabs which are insertable into openings in one of said walls of said housing for mounting said canopy to said housing without need for additional securement hardware.

2. A sign-type lighting fixture assembly of claim 1 wherein said housing includes apertures positioned on plural of said perimetrical walls for mounting said canopy to one of said plural perimetrical walls.

3. A sign-type lighting fixture assembly of claim 1 wherein said canopy includes a planar surface having a central extension trough extending there along.

4. A sign-type lighting fixture assembly of claim 3 wherein said trough includes a central aperture there through for allowing passage of electrical wires from the electrical box through the canopy and into the lighting fixture.

5. A sign-type lighting fixture assembly of claim 3 wherein said bendable tabs are positioned at opposite ends of the trough.

6. A sign-type lighting fixture assembly of claim 1 wherein one of the walls include an opening to facilitate entry of wires into the light fixture.

7. A sign-type lighting fixture assembly of claim 1 wherein said walls include flanges to support a face of the sign.

8. A sign-type lighting fixture assembly of claim 1 further includes an end cap to secure the sign within the perimetrical walls.

9. A sign-type lighting fixture assembly of claim 1 wherein said canopy is positioned on top of the perimetrical wall to secure the lighting fixture to the ceiling.

10. A sign-type lighting fixture assembly of claim 1 wherein said canopy is positioned on side of the perimetrical wall to secure the lighting fixture to the wall.
